(19) United States
(12) Patent Application Publication
(10) Pub. No.: US 2005/0091133 A1
(43) Pub. Date: Apr. 28, 2005

(54) A System and method for creating a capitalization table of a company

(76) Inventor: Glenn Ballman, Nevis (VG)

Correspondence Address: JEFFREY FURR, 253 N. MAIN STREET, JOHNSTOWN, OH, 43031, US

(21) Appl. No.: 10/605,755

(22) Filed: Oct. 23, 2003

(51) Int. Cl. G06F 17/60

(52) U.S. Cl. 705/35

(57) ABSTRACT

The current invention is a securities system which takes the capitalization table of a company and enables shareholders to create corresponding shareholder accounts in the exchange. These accounts are verified as the actual person by checking against a known identity database such as Social Insurance Number, Social Security Number, Drivers License, Passport number, Credit Card number or equivalent. In the second step, they are verified as the Beneficial Rights Holders by a Certification Party (Legal Firm, Accountant or other professional party). Third step—the Certification Party verifies the capitalization table has been entered accurately. The Exchange then constantly reconciles the capitalization table each time a trade is conducted so 100% of the Beneficial Rights Holders are identified and verified.

### BACKGROUND OF INVENTION

1. Field of the Invention

The present invention relates to a data processing system and method for creating a capitalization table of a company, for tracking and updating changes in a capitalization table as trades occur, and more particularly enabling shareholders to create corresponding shareholder accounts in an exchange.

2. Description of Prior Art

The Internet comprises a vast number of computers and computer networks that are interconnected through communication links. One use of the Internet is to search for information or to perform functions such as the buying and selling of stocks and securities.

A market is defined as the means through which buyers and sellers are brought together to aid in the transfer of goods/services. There is no need to have a physical location or ownership of the goods and services it helps sell and it can deal in a variety of goods and services. When dealing with securities markets there are Primary markets, which deal with new issues, and Secondary markets where outstanding (existing) securities are bought and sold.

When dealing with Securities exchanges there are: Auction vs. dealer market. In a pure auction market, buyers and sellers are matched by a broker at a central location. An auction market is a price driven market. In a dealer market, dealers provide liquidity by buying and selling shares. Dealers may compete against other dealers.

Call vs. continuous market. Call markets trade individual securities at specified times to gather all orders and determine a single price to satisfy the most orders. Theseprices are used for opening prices on NYSE if orders build up overnight or after trading is suspended. Continuous markets trade any time the market is open.

Some of the national security exchanges offer a large number of listed securities, prestige of firms listed, wide geographic dispersion of listed firms and diverse clientele of buyers and sellers. Some of these security exchanges are: The New York Stock Exchange (NYSE) which is the largest organized securities market in the United States. It was established in 1817, but dates back to the 1792 Buttonwood Agreement by 24 brokers. It now has over 3,000 companies with securities listed and a market value over $11 trillion in 2000.

The American Stock Exchange (AMEX) which was started by a group who traded unlisted securities at the corner of Wall and Hanover Streets in New York as the Outdoor Curb Market. It has an emphasis on foreign securities and doesn't trade securities listed on NYSE. Warrants traded on AMEX years before NYSE listed any.

Other National Exchanges are the Tokyo Stock Exchange (TSE) and the London Stock Exchange (LSE). There are also new exchanges in emerging countries such as: Russia, Poland, China, Hungary, Peru, Sri Lanka.

The characteristics of a good Securities Market are the following: the availability of past transaction information which is timely and accurate; liquidity, the ability to buy or sell an asset at a known price; marketability, the ability to buy/sell quickly; price continuity with no huge jumps in prices without new information; depth, a number of buyers and sellers present; low transaction cost, the lower the more efficient; and informational efficiency where prices adjust quickly to new information and reflect all available information.

Daily trading volume of securities has increased from 5 million shares to over 420 million shares. The NYSE routinely handles volume over 400 million shares, and had a daily high of more than 700 million in 1998. Technology has allowed the market process to keep pace. Some of these technological advances are as follows: The Super DOT: Electronic order-routing system where member firms transmit market and limit orders in NYSE securities to trading posts or a member firm's booth. The report of execution is returned electronically; 85% of NYSE market orders enter through Super DOT system.

The Display Book: an electronic workstation that keeps track of all limit orders and incoming market orders, including incoming Super Dot limit orders.

The Pre-opening Market Orders for Super Dot System: automatically and continuously pairs buy and sell orders. It presents imbalances to the specialist prior to the opening of a security, helps determine opening price and potential need for pre-opening call market.

The Market Order Processing: Super Dot's post-opening market order system. This allows for rapid execution and reporting of market orders.

Limit Order Processing: electronically files orders to be executed when and if a specific price is reached. This updates the Specialist's Display Book. Good-until-cancelled orders that are not executed are stored until executed or cancelled.

There are certain major types of securities orders, such as: Market orders are buy or sell at the best current price and provide immediate liquidity.

Limit orders are orders that specify the buy or sell price and have time specifications which may vary: Instantaneous—“fill or kill”, part of a day, a full day, several days, a week, a month, or good until canceled (GTC).

Short sales are the sell of overpriced securities that are not owned and are then purchased back later at a lower price. The investor borrows the security from another investor (through a broker). It can only be made on an up-tick trade, must pay any dividends to lender and margin requirements apply.

Special Orders are sells such as: Stop loss which is a conditional order to sell a security if it drops to a given price but it does not guarantee price received upon sale and market disruptions can cancel such orders; and Stop buy orders in which an Investor who sold short may want to limit loss if a security increases in price.

Margin Transactions which are on any type order, wherein instead of paying 100% cash, an investor can borrow a portion of the transaction, using the security as collateral. The interest rate on margin credit may be below prime rate and Regulations limit proportion borrowed. Margin requirements (proportion of cash payment) are from 50% and up.

Changes in a security price affect investor's equity Various computerized systems for providing financial services and for facilitating financial transactions are known in the art. U.S. Pat. No. 6,304,858 issued on Oct. 16, 2001 to Mosler et al. discloses a computer-implemented system for trading in which a standardized contract is traded. The contract obligates a buyer and a seller to settle the contract based on a price of the contract at a first effective date. The contract is traded through an exchange, and a price of the contract is determined from certain financial factors. U.S. Pat. No. 6,014,643 issued on Jan. 11, 2000 to Mosler et al. discloses an interactive securities trading system. Sellers and buyers of securities may transact through the system. Upon acceptance by a buyer of a seller's offer, the buyer's account is debited and the buyer receives title to the purchased securities.

Published Street Name Trading was started in the 1950s to overcome the paper tiger of physical note trading for securities. Basically it means that only the brokerage name is transmitted and displayed in the order book. This creates problems in allowing regulators and others to see who the rights holder/beneficial owner is. This can lead to fraud and manipulation.

The Capitalization Table of an untraded issuer of shares is intended to track the interest holders accounts in the issuer. However, when an issuer starts publicly trading—the capitalization table no longer updates the shareholder information with the names of the new beneficial rights/share owners. In essence the issuer knows HOW MANY shares are trading in the market with volume and brokerage house information—but has very little or no visibility into WHO the beneficial share owners are.

This causes several potential problems. For example—an issuer that wishes to communicate with all of its shareholders or conduct a shareholder vote, must pay a third party such as a trust company or transfer agent to generate a list of all shareholders for a given day and obtain their physical addresses. Further, the issuer must then mail the information or voting documents to the shareholders. This process can take several weeks and be prohibitively expensive for an issuer. A constantly updated capitalization table will enable the issuer to instantly access the list of beneficial shareholders at any given moment and send an electronic mail message to them each rights holder regarding an important shareholder notice or vote with little or no cost.

There exists a need to improve the tracking of the capitalization table of a company, and direct communication with investors, potentially thereby reducing fraud, and risk and increasing liquidity. There is still need for improvement in the art.

### SUMMARY OF INVENTION

The present invention takes the capitalization table of a company and enables shareholders to create corresponding shareholder accounts in an exchange. These accounts are verified as the actual person by checking against a known identity database such as Social Insurance Number, Social Security Number, Drivers License, Passport number, Credit Card number, credit evaluation system or equivalent. In the second step, they are verified as the Beneficial Rights Holders by a Certification Party (Legal Firm, Accountant or other professional party). Third step—the Certification Party verifies the capitalization table has been entered accurately. The Exchange then constantly reconciles the capitalization table each time a trade is conducted so 100% of the Beneficial Rights Holders are identified and verified.

The capitalization table can also be displayed through a Wireless device such as a PDA or cell phone.

The present invention relates to a data processing system and method for managing broker transactions and information in compliance with governmental regulations. The data processing system further provides for managing other types of broker transaction information such as client profiles, and for providing security measures which enhance the ability to prevent unauthorized trade activities. Some specific functional aspects of the data processing system of this invention include the ability to monitor and record any and all data changes made to previously entered trade records. This audit function prevents the changing of any trade record data without some record being made thereof in the main database. This is an additional security feature which further ensures that all data is entered and recorded, whether it be the entry of original data for a trade transaction, or necessary changes which sometimes need to be made to trade data. A trade audit report may be generated which shows a change status with regard to each trade record. The data processing system and method of the invention results in a comprehensive means to assist broker/dealer representatives, local brokerage offices, and government regulators in dealing not only with SEC rules, national, international and regional, but to better record and track all operations of an investor to recognize potential fraud.

An objective of the current invention is to provide a capitalization table that is easy to use and to approve.

Other objectives and advantages of the present invention will become obvious to the reader and it is intended that these objectives and advantages are within the scope of the present invention.

To accomplish the above and related objectives, this invention may be embodied in the form illustrated in the accompanying drawings, attention being called to the fact, however, that the drawings are illustrative only, and that changes may be made in the specific construction illustrated.

Definitions:

Browser: a software program that runs on a client host and is used to request Web pages and other data from server hosts. This data can be downloaded to the client's disk or displayed on the screen by the browser.

Capitalization table (Cap table): a table of the interest holders accounts in the company.

Client host: a computer that requests Web pages from server hosts, and generally communicates through a browser program.

Content provider: a person responsible for providing the information that makes up a collection of Web pages.

Embedded client software programs: software programs that comprise part of a Web site and that get downloaded into, and executed by, the browser.

Host: a computer that is connected to a network such as the Internet. Every host has a hostname (e.g., mypc.mycompany.com) and a numeric IP address (e.g., 123.104.35.12).

HTML (HyperText Markup Language): the language used to author Web Pages. In its raw form, HTML looks like normal text, interspersed with formatting commands. A browser's primary function is to read and render HTML.

HTTP (HyperText Transfer Protocol): protocol used between a browser and a Web server to exchange Web pages and other data over the Internet.

HyperText: text annotated with links to other Web pages (e.g., HTML).

IP (Internet Protocol): the communication protocol governing the Internet.

SEC: the Security and Exchange Commission.

Securities: For the purposes of this application, securities mean 1. Equities, Debt, Convertible Debt, Convertible Promissory Notes, Convertible Loans, Debentures, Warrants, Options, Special Warrants, Fixed Value Contracts, Futures, Derivatives, Commodities, Bonds, Fixed Income Products, Dividend Rights 2. Predictive market instruments 3 Games and fantasy securities traded within fantasy games that are not securities but mimic the actions or features of securities or other markets 4. Contracts 5. Points or rewards 6. Tax and legislative credits such as carbon credits 7. Anti money laundering; antiterrorism prediction; and other regulatory and military decision making trading instruments; 8 Rights such as mineral or timber rights.

Server host: a computer on the Internet that hands out Web pages through a Web server program.

Shares: For the purposes of this application, shares means a unit or units of ownership interest in a security as defined above.

URL (Uniform Resource Locator): the address of a Web component or other data. The URL identifies the protocol used to communicate with the server host, the IP address of the server host, and the location of the requested data on the server host. For example, “http://www.lucent.com/work.html” specifies an HTTP connection with the server host www.lucent.com, from which is requested the Web page (HTML file) work.html.

UWU server: in connection with the present invention, a special Web server in charge of distributing statistics describing Web traffic.

Visit: a series of requests to a fixed Web server by a single person (through a browser), occurring contiguously in time.

Web master: the (typically technically trained) person in charge of keeping a host server and Web server program running.

Web page: multimedia information on a Web site. A Web page is typically an HTML document comprising other Web components, such as images.

Web server: a software program running on a server host, for handing out Web pages.

Web site: a collection of Web pages residing on one or multiple server hosts and accessible through the same hostname (such as, for example, www.lucent.com).

### BRIEF DESCRIPTION OF DRAWINGS

Various other objects, features and attendant advantages of the present invention will become fully appreciated as the same become better understood when considered in conjunction with the accompanying drawings, in which like reference characters designate the same or similar parts throughout the several views, and wherein:

FIG. 1 shows how a user would access the Internet system;

FIG. 2 shows how securities are traded;

FIG. 3 shows a Cap table of a company;

FIGS. 4a, 4b, 4c and 4d shows the initial steps in creating a Cap table;

FIG. 5 shows the second step in creating a Cap table;

FIG. 6 displays the completed Cap table;

FIG. 7 displays an E-mail message to someone not a member of the exchange;

FIG. 8 displays a marker order book of the current invention; and

FIG. 9 displays a sample portfolio screen of the current invention.

### DETAILED DESCRIPTION

The present invention takes the capitalization table of a company and enables shareholders to create corresponding shareholder accounts in an exchange. This can work with a electronic Market Order Book and more particularly with a Securities Exchange System as described in more detail in patent application Ser. Nos. 10/604766 and 10/604762 which are incorporated by reference. These accounts are verified as the actual person by checking against a known identity database such as Social Insurance Number, Social Security Number, Drivers License, Passport number, Credit Card number or equivalent. In the second step, they are verified as the Beneficial Rights Holders by a Certification Party (Legal Firm, Accountant or other professional party).Third step—the Certification Party verifies the capitalization table has been entered accurately. The Exchange then constantly reconciles the capitalization table each time a trade is conducted so 100% of the Beneficial Rights Holders are identified and verified.

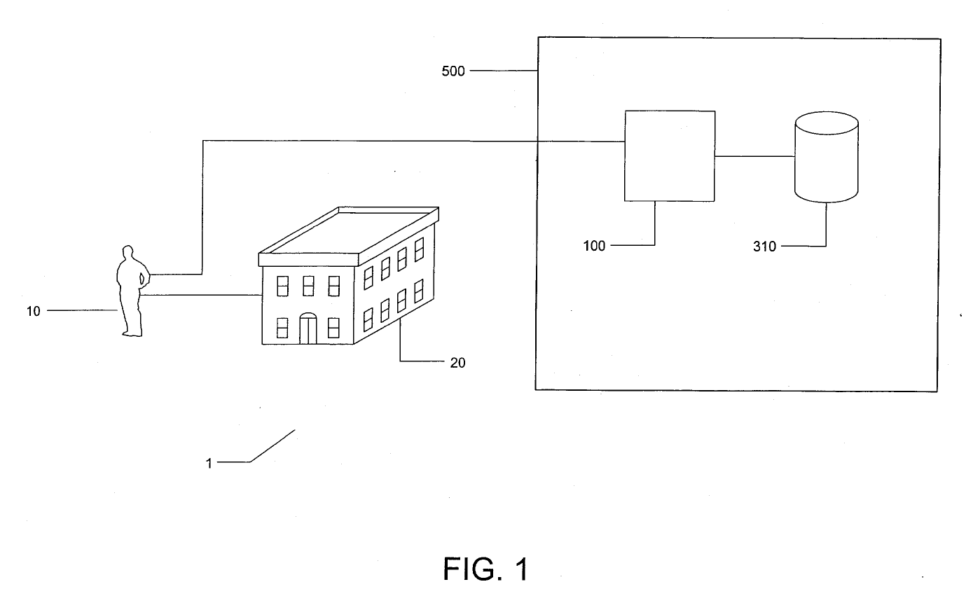

FIG. 1 illustrates a functional diagram of a computer network for World Wide Web 500 access to the System 1 from a plurality of Users 10 who access the System Web Site 100 or the Users 10 can connect directly to the System 1. Accessing the System Web Site 100 can be accomplished directly through a communication means such as a direct connection, an intranet, a local Internet Service Provider, often referred to as ISPs, or through an on-line service provider like CompuServe, Prodigy, American Online, etc. or Wireless devices using services like AT&T or Verizon.

The Clients 20 and users 10 contact the System Web Site 100 using an informational processing system (Client) capable of running an HTML compliant Web browser such as Microsoft's Internet Explorer, Netscape Navigator, Lynx and Mosaic. A typical system that is used is a personal computer with an operating system such as Windows 95, 98 or ME, NT, 2000, XP or Linux, running a Web browser. The exact hardware configuration of computer used by the Clients 20, the brand of operating system or the brand of Web browser configuration is unimportant to understand this present invention. Those skilled in the art can conclude that any HTML (Hyper Text Markup Language) compatible Web browser is within the true spirit of this invention and the scope of the claims.

In one preferred embodiment of the invention, the Users 10 and/or clients 20 connect to the System Web Site 100. In the preferred embodiment the system has numerous web pages. The information in the web pages are in HTML format via the HyperText Transport Protocol (http) and on Server System 310. The User System 110 includes software to allow viewing of web pages, commonly referred to as a Web Browser, such as Communicator available from Netscape Communications Corp. or Internet Explorer available from Microsoft Corp. The user system is capable of accessing web pages located on Server System 310.

Output can include a graphical user interface, hardcopy, facsimile, e-mail, messaging or other communication with any humanly or machine discernable data and/or artifacts. In some embodiments, output can include transmitting the risk variable related data to a designated recipient, any humanly or machine discernable data and/or artifacts.

The data processing System 1 allows for secure input, data transfer and storage of a wide array of information. The System 1 allows and handles the direct transfer of security rights and the broker is given the ability to trade only as an agent for the client. The input, data exchange and storage of the data is achieved by electronic data transmission, thus eliminating the need for paper logs. In a first embodiment of the invention, as further discussed below, means for processing data is provided which includes computer software installed at various locations within the data processing system. In a second embodiment of the invention, the data processing system has means for processing data which is installed on a web server computer; therefore, there is but one necessary installation of the means for processing data, and users log on to a website and conduct functions within the data processing system through the web server. The first embodiment can also be referred to as a Windows™ version, and the second embodiment can be referred to as aweb browser version. The functionality of both embodiments is essentially the same; however, the second embodiment or the web browser version may incorporate some additional enhancements, as further discussed below. The data processing system in both embodiments utilizes a secure environment to transmit all data through encryption/decryption. The data processing system further provides for an audit trail of modifications made to the recorded data. The data processing System 1 for both embodiments includes computer processing means for processing data, storage means for storing data on a storage medium, and communication means for transferring data in a secure environment.

For the first embodiment on the Windows™ version, the data is entered on remote work stations and stored in local databases until the user performs a data transmission function which electronically transfers the data to a central database. The central database acts as a central repository enabling multiple off-site users to view and/or modify data, and generate reports or output. For the second embodiment or the web browser version, it can be conceptually broken down into two main components or groupings that allows the data processing system toachieve its functionality. They are as follows: (1) a main database that acts as the central repository for data entered into the system and (2) a means for processing data or computer software means in the form of coded computer instructions.

For the web browser version, it is unnecessary to have the different installations of the computer software because the web server computer has the entire means for processing loaded thereon. The user in the web browser version logs on to the website and then performs desired functions based upon functions made available to the type of user. There are two ways in which data is entered through the browser version: (1) through a website and transmitted via a LAN or the worldwide web to the web server. The web server then forwards the data to the database; or (2) through a data feed from a separate third party electronic online trading system and transmitted via a LAN or the worldwide web to the web server or an FTP server. The web server or FTP server then forwards the data to the main database. Transmission of data in the second embodiment via the worldwide web or LAN is also secure utilizing data encryption/decryption provided by SSL. Other than consolidation of the means for processing data at the web server computer, and the manner in which data is entered and retrieved through a website, the first and second embodiments have the same functionality, except for those additional features discussed below with respect to the second embodiment.

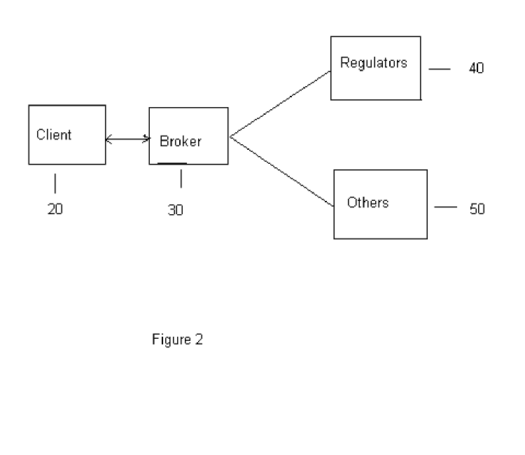

As shown in FIG. 2, currently a client 20 desires to buy or sell securities. This can be done by a broker 30 in the current art.

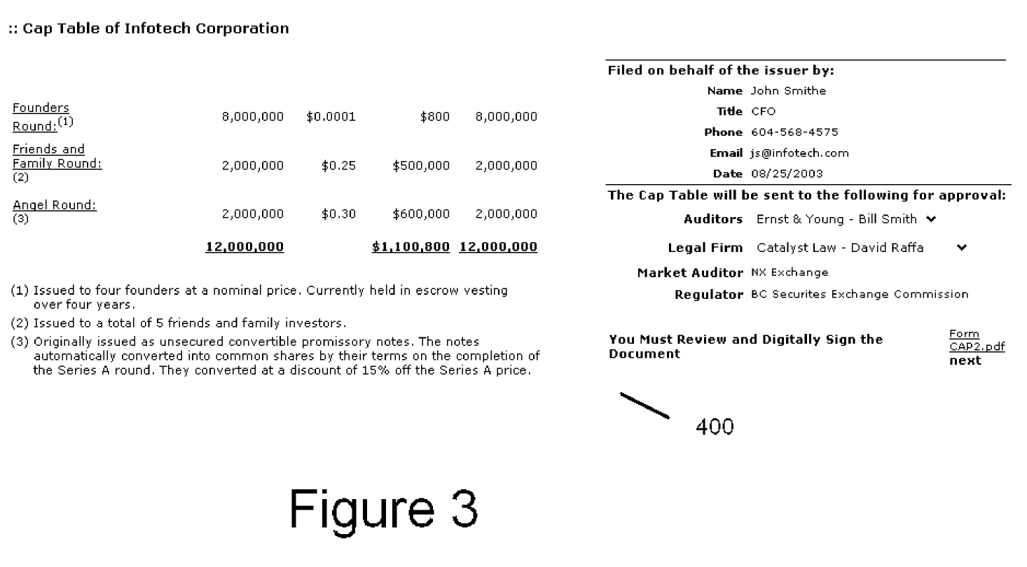

A summarized capitalization table of a company is shown in FIG. 3. It displays amount of interest that each type of interest holder has as well as the capital that it represents as well as the number of shares in each class and the amount of shares that are available for granting. It also has a cap table 400 change log which shows the changes that have effected the cap table.

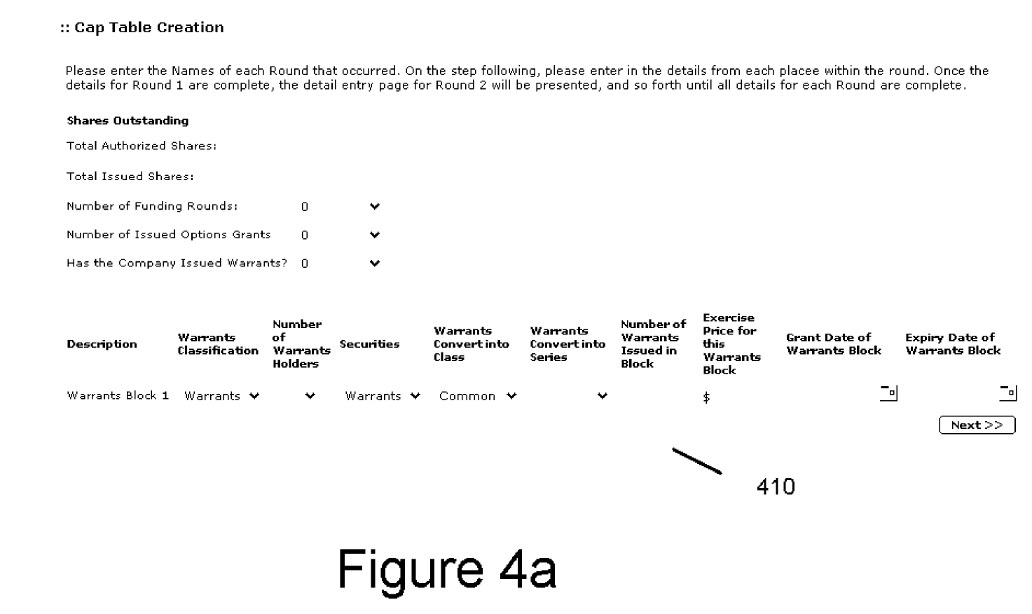

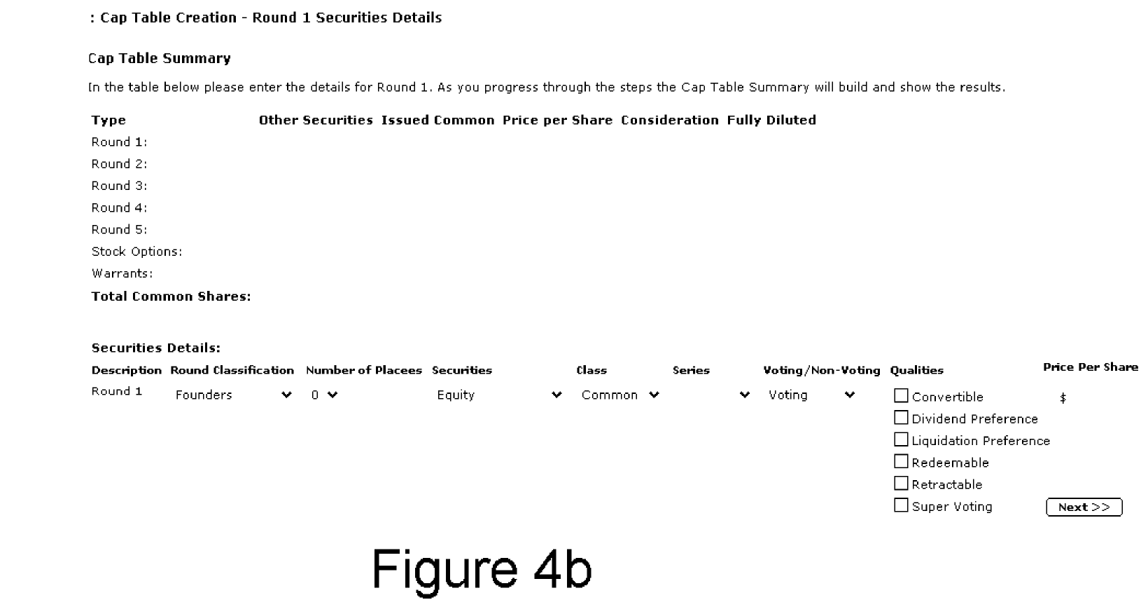

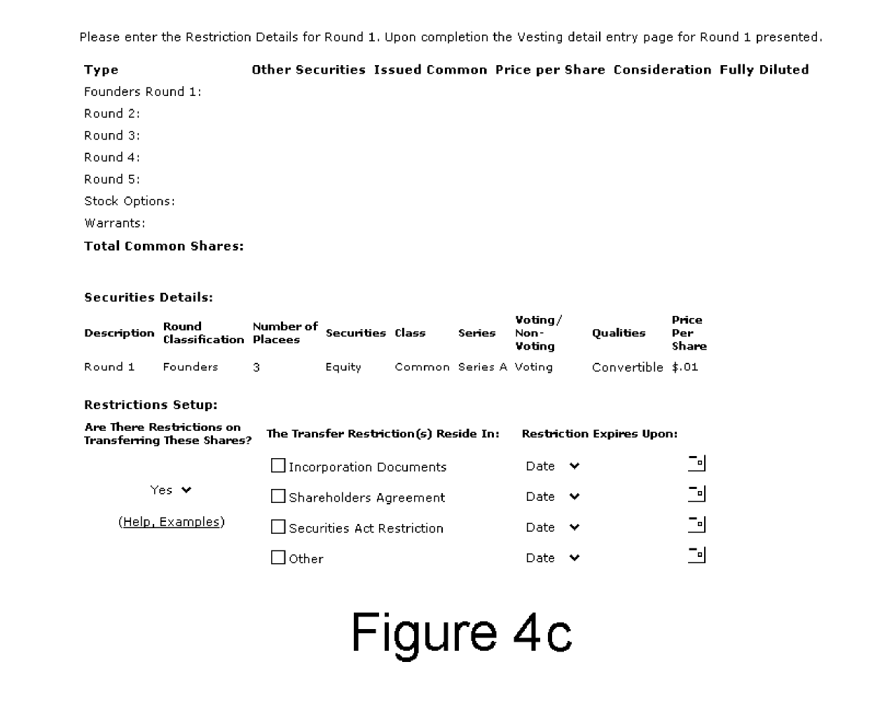

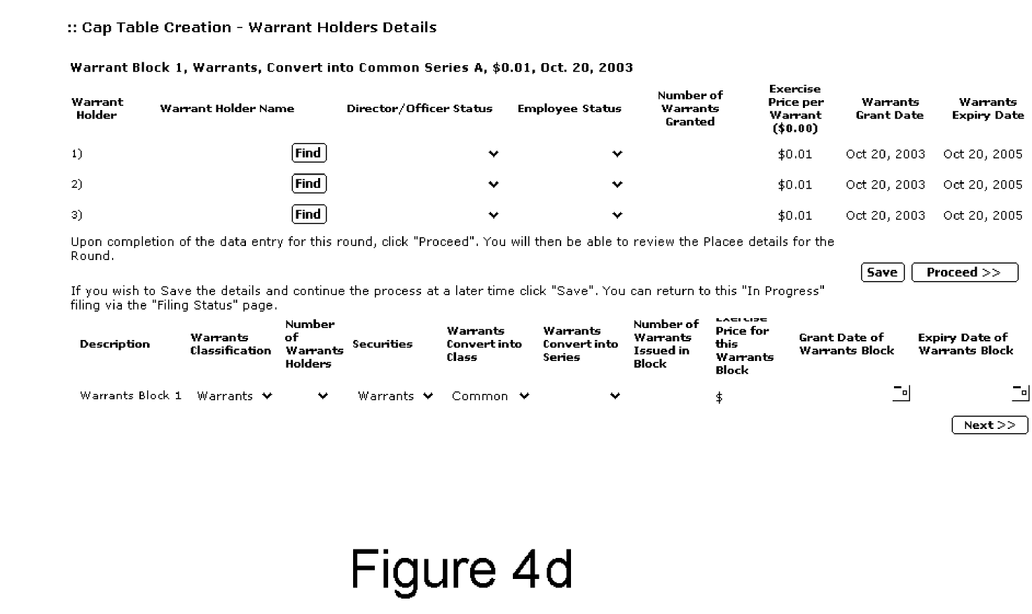

The creation of the capitalization table 400 is done by a securities System 1. This System 1 is a computer based data securities market and processing system where the capitalization table accesses and modifies the securities System 1 database. FIG. 4a, displays an input screen 410 for the current invention. The input screen 410 asks for the user 10 to input the total number of authorized and issued shares. After the total number of authorized and issued shares are entered the user 10 of the System 1 is asked to enter the number of investment rounds, enter the number of options grants, enter information if there is an options pool, and enter the number of warrants blocks.

Next the system configures a form and prompts the user to enter the following investment details as shown in FIG. 4b: 1. Round Classification: Founders; Friends/Family Angel; Venture Capital; Institutional; Strategic; Mezzanine; Other 2. Number of Placees: [numeral is entered]3. Securities Type: Equity; Convertible Debt; Options; Warrants; Special Warrants a Convertible Debt Sub Categories: Promissory Note; Loan; Debenture; Other 4. Securities Class: Common or Preferred 5. Series of Issuance: Series A; Series B; Series C; Series D; Series E; through Series Z (a) Alternatively: Series I, Series II, Series III using Roman Numerals (b) Alternatively: Series 1, Series 2, Series 3 using alphanumeric 6. Voting Characteristics: Voting or Non-Voting 7. Securities Qualities: Convertible, Dividend Preference, Liquidation Preference, Redeemable, Retractable, Super Voting 8. Price Per Security For Options Grants, as shown in FIG. 4c, the system reconfigures the information and forms to prompt the user for slightly different information applicable to options: 1. Options Classification: Stock Options Standard, Employee Stock Option Plan, or Non-Employee Stock Options 2. Number of Options Holders 3. Options Securities Classification: Standard Options, Incentive Stock Options (ISOs), Non-incentive Stock Options (Non-ISO's) or Other Securities Classification 4. Options Convert Into Class: Common; Preferred 5. Options Convert Into Series: Series A; Series B; Series C; Series D; Series E; through Series Z (a) Alternatively: Series I, Series II, Series III using Roman Numerals (b) Alternatively: Series 1, Series 2, Series 3 using alphanumeric 6. Number of options approved for grant: Numeric entry 7. Number of options granted: Numeric Entry 8. Option Exercise Price for the Grant: Numeric price entry 9. Date of Options Grant: Date Entry For Warrants issuance, as shown in FIG. 4d, the system reconfigures the information and forms to prompt the user for slightly different information applicable to warrants: 1. Warrants Classification: Standard, Special, Other 2. Number of Warrants Holders: Numeric entry 3. Warrants Securities Classification: enter any special types of warrants 4. Warrants Convert Into Class: Common; Preferred 5. Warrants Convert Into Series: Series A; Series B; Series C; Series D; Series E; through Series Z (a) Alternatively: Series I, Series II, Series III using Roman Numerals (b) Alternatively: Series 1, Series 2, Series 3 using alphanumeric 6. Number of Warrants issued in block: Numeric entry 7. Exercise Price for Warrant Block: Numeric price entry 8. Expiry Date of Warrants: Date Entry After this is done, the user 10 hits the next button to be taken to the next screen and have the data inputted added to the System 1.

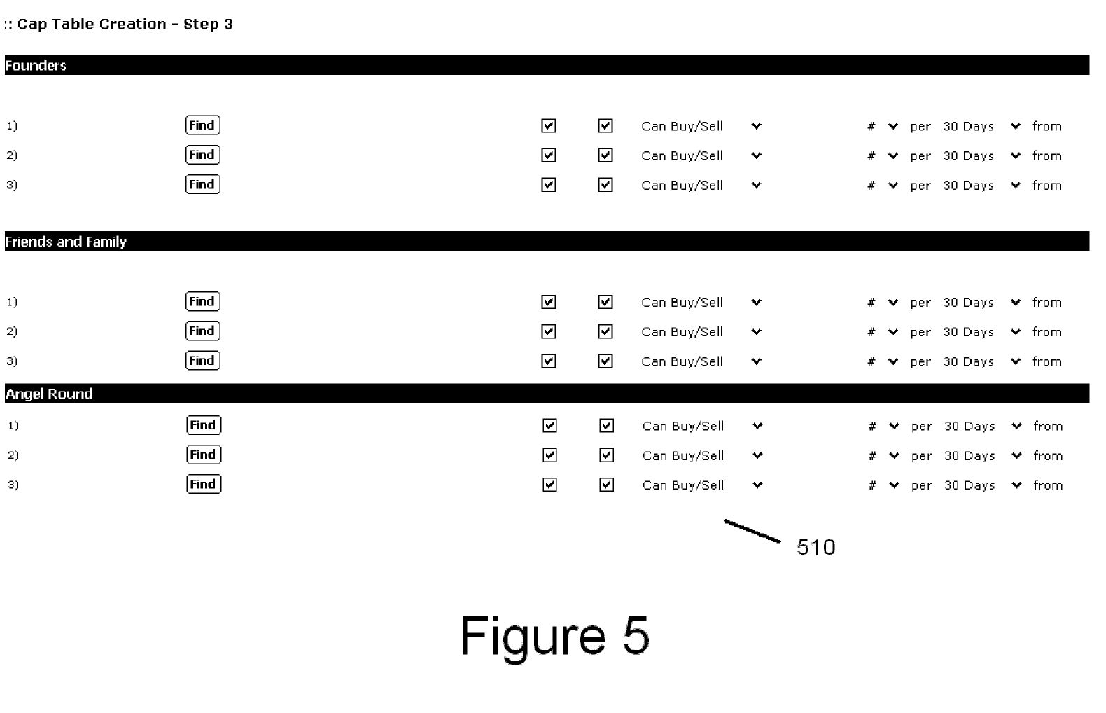

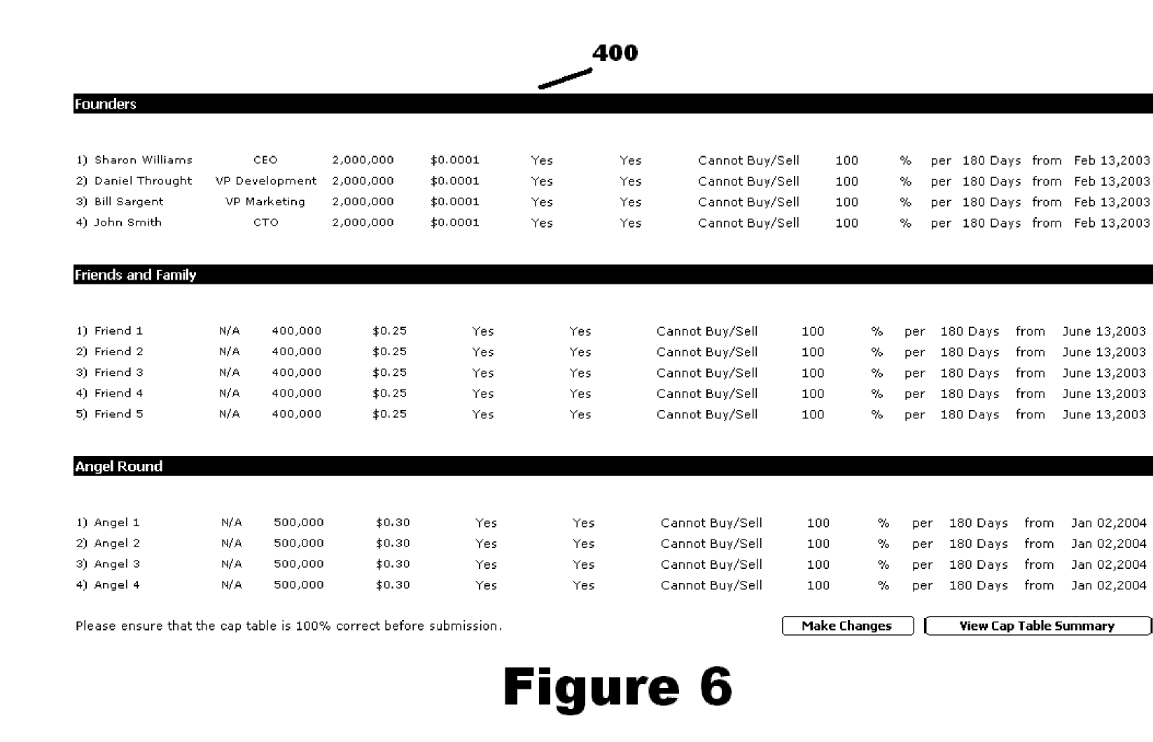

As shown in FIG. 5, the system uses the data entered in screen 410 to form a detailed input screen 510. The detailed input screen 510 breaks each of the shareholder types into the individual share or rights holder. For each of the individual shareholders/interest holders the user 10 enters: the legal name of the shareholder whether it is a person's name, company, trust or any other legal entity; the employment or economic relationship status that the shareholder has with the issuer of the securities, the position that the shareholder has in the issuer of the securities; the number of shares owned; the price paid per share; whether they can buy or sell the securities, which in the preferred embodiment is a check box, checked for yes, uncheck for no; any restrictions on the shares, in the preferred embodiment this is done by a dropdown list; the share limit restriction that that shareholder has; the type, whether a percentage or number limit on the share limit restriction; and the time that the shareholder has to buy or sell the shares from a certain date. Once entered by the user 10 the user 10 clicks a view cap table summary button. That will bring up a filled out capitalization table 40 as shown in FIG. 6.

The capitalization table is displayed via the Internet 500. A computer 35 connected to the Internet 500 can view the results of the capitalization table.

The Cap table can also be displayed through a Wireless device such as a PDA 130 or cell phone 140.

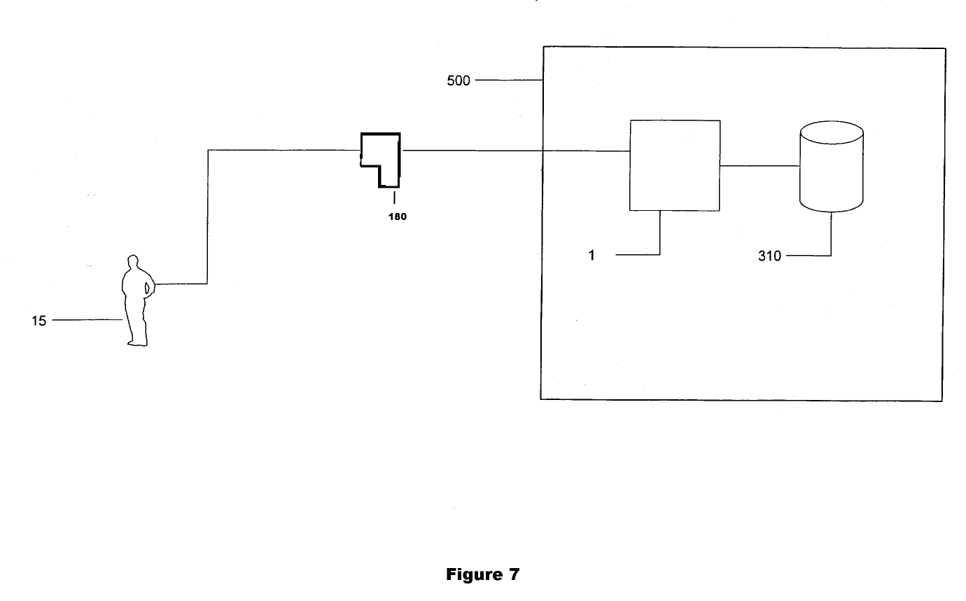

If one of the shareholders entered by the user 10 is not a member of the exchange system the System 1 will generate an E-mail message 180 to that shareholder inviting them to join the exchange system. This is shown in FIG. 7.

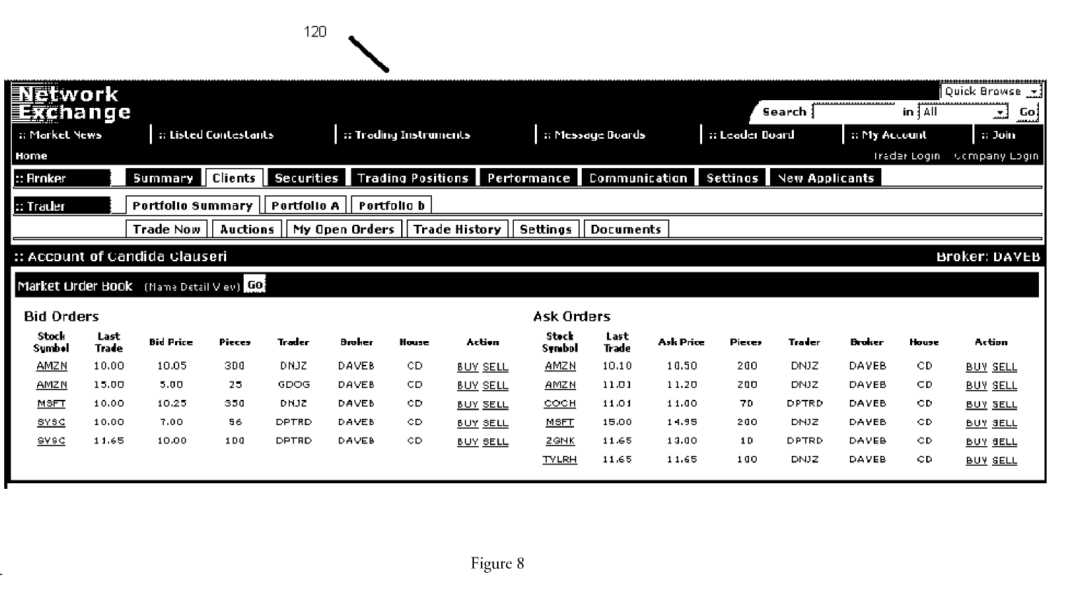

FIG. 8 shows a tentative screen view of a sample of the current invention's Market Order Book 120. The Book 120 in the preferred embodiment has the following fields.

On bid orders there are the following fields; Security symbol, which is the symbol that signifies the stock or security being traded. Last Trade is the last trading price. Bid Price is the bid that the bidder is offering. Pieces is the number of shares or pieces of the security wanted. Trader is the actual beneficial rights holder of the transaction, not the broker.

On ask orders there are the following fields; Security symbol, which is the symbol that signifies the stock or security being traded. Last Trade is the last trading price. Ask Price is the bid that the asker is wanting. Pieces is the number of shares or pieces of the security wanted. Trader is the actual beneficial rights holder of the transaction, not the broker.

The order book will use colors for the auction order book price display. Red will be used for downward prices for day, while green will be used for upward prices for the day.

In the preferred embodiment, the order book has the actual rights holder, but it also has a place for special symbols indicating that the seller or buyer is a Director or Officer or both of the company (D,O, DO), Is an Executive (EXE) Is an employee (EM), Is an Advisor or Consultant (A, C) broker name/symbol and the broker house/symbol to be attached. The name of the rights holder 20, and the name of the broker 30, and the name of the broker house can be changed to 6 letter symbols for the reduction of space—for example:

Action Shares Security Holder Qualities Agent Firm

Buy 1000 GEF U RR DO, EXE, E TE BRNOD BRUN

This is an order for 1000 GE shares from Furr placed by his agent/broker Ted Brown, from the firm Odlum Brown.

The system 1 will give users 10 the option to view the order book in “full name” or “symbols” mode. The advantage here is that regulators 40 and traders 20 are again given more visibility into fraudulent or manipulative transactions that might be occurring within a firm—such as wash trading or high closing. This is shown below:

Action Shares Security Holder Agent Firm

Buy 1000 GE JEFFREY FURR TERRY BROWN Odlum Brown

In the system 1, the trader is actual beneficial rights holder of the securities being traded, not the broker. The system verifies the identity of the beneficial rights hold by reconciling the identification against a verification method such as Social Security number, tax returns, passport number or international equivalent.

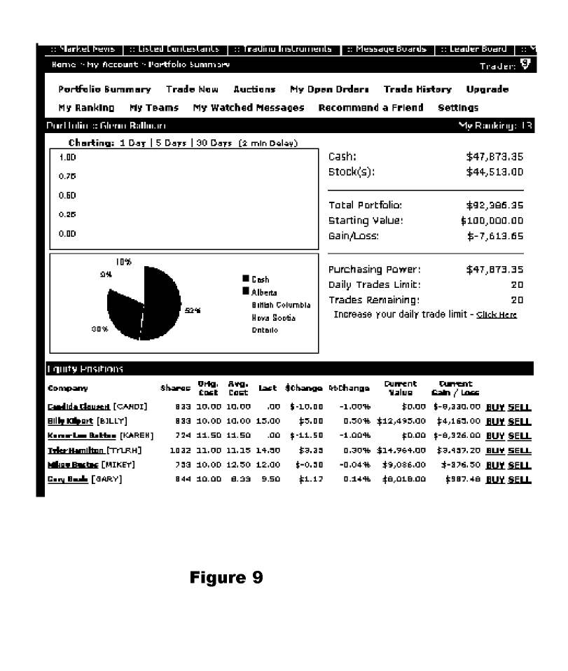

FIG. 9 shows the Portfolio Summary Screen of the current invention. It has been designed to displace as much information as possible to make it as useful as possible for the User 10.

It has the portfolio owner being listed in the upper right hand corner and can have a ranking for comparison to other traders. There is a charting display, which charts how well the portfolio is doing. This charting can be for 1, 5 or 30 days, or 1 year, 3 years or 5 years in the preferred embodiment. There is a pie chart that shows the percentages of each type of security represented in the portfolio. There is a display for the amount of cash and value of stocks and/or other types of securities that make up the portfolio as well as displaying the total portfolio value, starting portfolio value and the amount of gain or loss. It displays the purchasing power of the portfolio, the daily trades limit and amount of trades remaining.

The Portfolio Summary in the preferred embodiment will have the Equity Positions and Securities position held on the Portfolio displayed. This will include the Company name, the number of shares, the original cost of the shares, the average cost of the shares, the last quoted prices of the shares, the dollar change between the purchase price and quoted price, the percentage dollar change between the purchase price and the quoted price and the current value of the shares. This section will also have a buy/sell tab where a User 10 can click to either place an order for more shares or offer shares for sell. This buy/sell tab will allow buyers and sellers of securities to deal directly with each other as the rights holders.

The System 1 will allow regulators 40 and Others 50 to see and identify potential fraudulent securities trading behavior. In the preferred embodiment, the System will have securities traded under the rights holder's name and not the broker's name as the blocked nature of “streetname” trading under the broker's name can be used to hide transactions that the System 1 may want to stop with a static or dynamic break which gives regulators 40 a highly sophisticated set of tools to prevent, track, and prosecute fraud and manipulation.

The System 1 will be written using programming languages, techniques and knowledge that are commonly known in the art.

Alternative Embodiment

The current invention can apply not only to securities but also to 1. Games and fantasy shares 2. Predictive markets or collective probabilistic forecasting systems 3. Private equities and securities 4. Contracts 5. Points or rewards 6. Tax and legislative credits such as carbon credits 7. Rights such as mineral and timber rights 8. Royalty revenues or any other item that is actively traded.

Advantages

The previously described version of the present invention has many advantages. The system simplifies the creation of a capitalization table, allows faster less expensive communication with shareholders, and allows regulatorsgreater visibility thereby enabling them to enforce regulations with more effectiveness.

Although the present invention has been described in considerable detail with reference to certain preferredversions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A securities transaction system comprising of:
a system that allows the creation of a capitalization table.

2. A system that allows corresponding accounts for each beneficial rights holder or trust holder in the capitalization table;

3. A system according to claim 2 in which the total number of outstanding and authorized securities for an issuer are entered.

4. A system according to claim 2 in which the total number of outstanding securities are entered per beneficial rights holder; corporate or trust holder.

5. A system according to claim 1 in which said system is a data processing system.

6. A system according to claim 5 in which said system is processed in a client server system.

7. A system according to claim 5 in which said system is connected to through the Internet.

8. A system according to claim 5 in which said system is connected to wireless devices.

9. A system according to claim 5, further comprising: (a) computer processor means for processing data; (b) storage means for storing said data on a storage medium; (c) communication means for transmitting data in a secure environment to and from various remote locations; and (d) computer software means for creating and displaying trade data concerning a particular trade in the form of a trade record.

10. A system, as claimed in claim 9 wherein said computer software means further comprises: means for inputting and storing system information on said storage means.

11. A system according to claim 4 in which said system is a data processing system.

12. A system according to claim 11 in which said system is processed in a client server system.

13. A system according to claim 11 in which said system is connected to through the Internet.

14. A system according to claim 11 in which said system is connected to wireless devices.

15. A system according to claim 11, further comprising:
(a) computer processor means for processing data; (b) storage means for storing said data on a storage medium; (c) communication means for transmitting data in a secure environment to and from various remote locations; and (d) computer software means for creating and displaying trade data concerning a particular trade in the form of a trade record.

16. A system, as claimed in claim 15 wherein said computer software means further comprises: means for inputting and storing system information on said storage means.

17. A system according to claim 2 in which said system is a data processing system.

18. A system according to claim 3 in which said system is a data processing system.

19. A system according to claim 1 in which the trading of securities are done directly between rights holders.

20. A system according to claim 1 in which the system creates a static dynamic price instability alert and a separate dynamic price instability alert that senses the direction of the security and moves the price instability alert larger or smaller accordingly.

21. A system according to claim 1 in which the system moves an existing beneficial rights holder order book into a market auction after a price instability alert.

22. A system according to claim 1 which creates a invite to a shareholder who is not part of said system.

23. A system according to claim 1 which displays the beneficial rights holder in the order book during the auction bid and ask book creation.

24. A system according to claim 1 which displays and discloses the capitalization table to an issuer and other market participants as each security trade occurs.
